(19) United States
(12) Patent Application Publication
(10) Pub. No.: US 2019/0257012 A1
(43) Pub. Date: Aug. 22, 2019

(54) ARMOURING MACHINE ASSEMBLY WITH AN ADJUSTABLE GUIDE PLATE

(71) Applicant: Bartell Machinery Systems, L.L.C., Rome, NY (US)

(72) Inventor: Walter F. Thompson, Lindsay (CA)

(73) Assignee: Bartell Machinery Systems, L.L.C., Rome, NY (US)

(21) Appl. No.: 16/281,591

(22) Filed: Feb. 21, 2019

Related U.S. Application Data
(60) Provisional application No. 62/633,989, filed on Feb. 22, 2018.

(51) Int. Cl. D04C 3/22; D04C 3/36

(52) U.S. Cl. CPC D04C 3/22; F16L 11/082; D04C 3/36

(57) ABSTRACT

An assembly for an armouring machine may include a support disk, the support disk defining a central opening for receiving a pipe and a plurality of perimeter openings for receiving a plurality of strips, and the support disk being rotatable about a longitudinal axis passing through the central opening. The assembly may further include a guide plate surrounding the longitudinal axis and including a plurality of guide structures, the guide structures being positioned for receiving the strips as they move downstream from the support disk. The assembly may further include an actuation device that is mechanically coupled to the guide plate, where actuation of the actuation device causes rotation of the guide plate with respect to the support disk.

### RELATED APPLICATIONS

This application claims the benefit of U.S. Provisional Application No. 62/633,989, filed Feb. 22, 2018, which is hereby incorporated by reference in its entirety.

### TECHNICAL FIELD

The present embodiments generally relate to machines for forming armour structures around the outer diameter of tubular members, such as pipes, to enhance strength, burst pressure, and other characteristics.

### BACKGROUND

In some industries, such as the oil and gas industry, pipes are often used to transport and/or store fluid. Flexible pipes may be desired due to their versatility for use in a variety of locations and ease of installation. For example, flexible pipe is typically used for deep water extraction of oil and gas to the surface. Another use is for providing passages for hydraulics, power cables, control wires, fiber optic cables, and the like. While flexible pipes have theft advantages, the flexible material typically used to form flexible pipes often lacks appropriate burst pressure, or maximum pressure that can be contained prior to failure, for certain applications. To overcome this shortcoming, one or more layers of armour can be placed around the outer surface of the pipe. For example, the pipe may be armoured with a layer of elongated strips wound about the outer surface of the pipe in a helical pattern. The strips are typically formed as rectangular or circular ships made of steel or another material with a high tensile strength.

To form the armour, the pipe is typically fed longitudinally through an armouring machine. Armouring machines typically include equipment that rotates about the longitudinal axis of the pipe while simultaneously feeding and winding the strips around the pipe's outer surface. Often, each layer of armour includes many strips placed next to each other on the outer surface of pipe. The pipe may be ted through multiple winding assemblies such that multiple layers of armour are provided.

A problem typically encountered when using armouring machines of the type described above is what is referred to as a “shingle.” A shingle occurs when one or more strips does not lay flat on the outer surface of the pipe (or on an outer surface of the underlying layer), and/or when one or more strips overlap, forming a discontinuity. Shingles are problematic because when they occur, the strips may fail to cover the entirety of the outer surface of the pipe or underlying layer, thus reducing the effectiveness of the armour. Further, in a multi-layer armour structure, when an underlying layer has a shingle, the problem may compromise layers above due to a discontinuous base surface.

At minimum, shingles typically require stoppage of the armouring process such that the armouring machine can be adjusted and the problem corrected. Machine adjustment often requires re-feeding (also re-stringing) the strips from reels of the armouring machine through a support disk and to a guide plate, which can be a lengthy and tedious process. More seriously, if left undetected, shingles may compromise the integrity of the pipe, which may increase the risk of issues such as leaks, explosions, implosions, and/or other problems when the pipe is in use.

### BRIEF SUMMARY

In one aspect, the present embodiments generally relate to an assembly for an armouring machine. The assembly may include a support disk, the support disk defining a central opening for receiving a pipe and a plurality of perimeter openings for receiving a plurality of strips, and the support disk being rotatable about a longitudinal axis passing through the central opening. The assembly may further include a guide plate surrounding the longitudinal axis and including a plurality of guide structures, the guide structures being positioned for receiving the strips as they move downstream from the support disk. The assembly may further include an actuation device that is mechanically coupled to the guide plate, where actuation of the actuation device causes rotation of the guide plate with respect to the support disk.

In another aspect, the present embodiments generally relate to another assembly for an armouring machine with a support disk, the support disk defining a central opening for receiving a pipe and a plurality of perimeter openings for receiving a plurality of strips, and the support disk being rotatable about a longitudinal axis passing through the central opening. The assembly may further include a guide plate surrounding the longitudinal axis and including a plurality of guide structures, the guide structures being positioned for receiving the strips as they move downstream from the support disk. The assembly may further include a support arm with a first end coupled to the support disk and a second end coupled to the guide plate, the support arm having an adjustable portion with a variable length. Varying the length of the adjustable portion may move the guide plate axially along the longitudinal axis with respect to the support disk.

In another aspect, the present embodiments generally relate to a method for forming an amour layer around an outer surface of a pipe. The method may include feeding a strip through a support disk, the support disk defining a central opening for receiving a pipe and a perimeter opening for receiving the strip, the support disk being rotatable about a longitudinal axis passing through the central opening. The method may further include feeding the strip to a guide plate, the guide plate having a main body surrounding the longitudinal axis and a plurality of guide structures for receiving the strip as the strip moves downstream from the support disk. The method may further include rotating the guide plate with respect to the support disk.

### BRIEF DESCRIPTION OF THE DRAWINGS

The invention can be better understood with reference to the following drawings/figures and description. The components in the figures are not necessarily to scale, emphasis instead being placed upon illustrating the principles of the invention. Moreover, in the figures, like referenced numerals designate corresponding parts throughout the different views.

FIG. 1 is an illustration showing a perspective view of an assembly when incorporated into an armouring machine in accordance with certain aspects of the present disclosure.

FIG. 2 is an illustration showing a perspective view of the assembly of FIG. 1 in isolation.

FIG. 3 is a photograph showing a guide plate for use in an armouring machine in accordance with certain aspects of the present disclosure.

FIG. 4 is an illustration showing a detailed close-up view of a portion of the assembly of FIGS. 1-2.

FIG. 5 is an illustration showing an adjustable portion of a support arm for axial movement of a guide plate in accordance with certain aspects of the present disclosure.

### DETAILED DESCRIPTION

The present embodiments are described with reference to the drawings in which like elements are referred to by like numerals. The relationship and functioning of the various elements of this invention are better understood from the following detailed description. However, the embodiments of the invention are not limited to the embodiments illustrated in the drawings. It should be understood that in certain instances, details have been omitted which are not necessary for an understanding of the present invention, such as conventional fabrication and assembly.

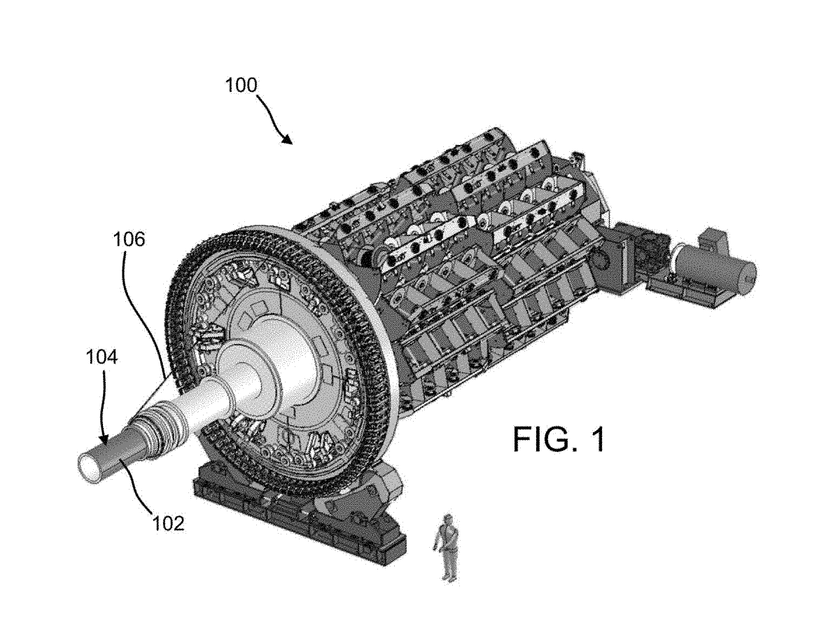

FIG. 1 is an illustration showing a perspective view of an assembly 100, which is a portion of an armouring machine. While the aspects of the present disclosure may be scaled such that they are applicable to machines of any size, and/or for any armouring application (e.g., armouring a different elongated body, such as a cable), the embodiments herein are generally described as forming an armour structure around a pipe 102, which may be sized for use in the oil and gas industry, for example for underwater applications. While any diameter and cross-sectional shape is contemplated, in certain exemplary embodiments, the pipe 102 may have a circular cross-section with an outer surface 104 having a diameter of about 70 mm to about 750 mm. A human is depicted in FIG. 1 for a non-limiting depiction of an exemplary scale.

The armour around the outer surface 104 of the pipe 102 may be formed with a set of strips 106. The strips 106 may be elongated strips formed of steel or another material with suitable tensile strength. While only one strip 106 is shown in FIG. 1 (for simplicity of explanation), any number of strips 106 may be used. For example, in some applications, up to about 96 strips are using in each armour layer, and multiple layers may be provided.

The strips 106 may have any suitable cross-sectional shape. For example, the strips 106 may have a cross-section that is rectangular and/or round (e.g., circular). One particular embodiment uses strips 106 with a rectangular cross-section measuring 22 mm in width and 10 mm in thickness. Other embodiments call for strips having different dimensions. When strips 106 with a rectangular cross-section are used, the strips 106 may be wound around the outer surface 104 of the pipe 102 in a helical manner with an application angle of about 25 degrees to about 55 degrees, and application angles out of this range are also contemplated. Herein, the “application angle” refers to the angle between the longitudinal axis of the strip 106 and the longitudinal axis 126 of the pipe 102. When other types of strips are used, such as circular strips, the application angle may be between about 13 degrees (or less) and may approach about 90 degrees. While winding, the assembly 100 may apply a tension to the strips 106 as the strips 106 are deployed, such as a tension of between about 150 daN (or less) and about 2000 daN (or more).

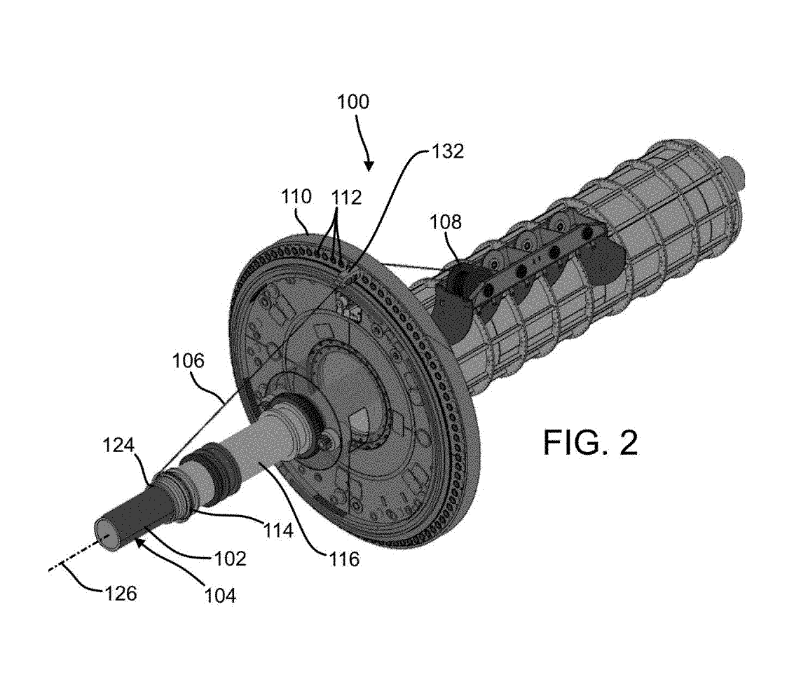

FIG. 2 is an illustration showing a perspective view of the assembly 100 in isolation with various reels and strips omitted. As shown, the assembly 100 may include a reel 108 for storing and feeding the strip 106. One red 108 may be included for each strip 106, and therefore many reels 108 may be included when multiple strips 106 are used (and extra reels may be included for storing unused strips). The reels 108 may be formed as spools that can rotate to feed the strips 106, and in some embodiments, rotation of the spools may be restricted/controlled to ensure the strips 106 are tensioned as they are fed downstream.

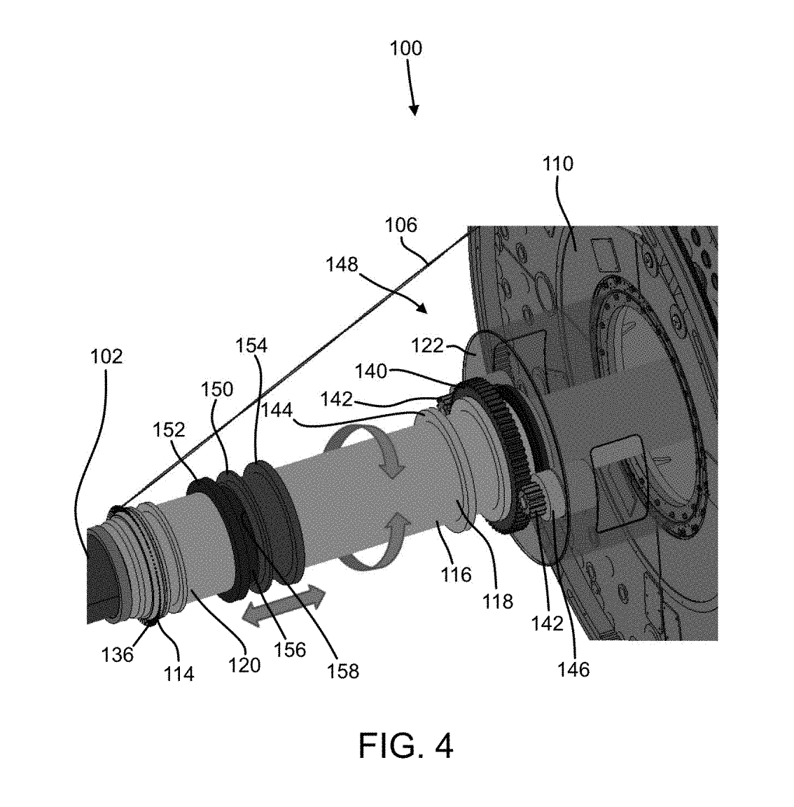

The assembly 100 may also include a support disk 110 with a set of perimeter openings 112 for receiving the reels 108. The perimeter openings 112 of the support disk 110 may be placed at or near the outer perimeter of the support disk 110 to properly space the strips 106 with respect to one another, thereby ensuring proper spacing as the strips 106 are fed downstream to a guide plate 114. As described in more detail below (with reference to FIG. 4), a support arm 116 may be located between the support disk 110 and the guide plate 114.

Still referring to FIG. 2, the assembly 100 may define an opening 124 extending along a longitudinal axis 126, which is the longitudinal axis of the pipe 102 when the process is active. The opening 124 may be sized to receive the pipe 102. That is, the opening 124 may have an inner diameter that is about the same as, or larger than, the outer diameter of the pipe 102 such that the pipe can be fed through the opening 124 along the longitudinal axis 126 (e.g., towards the viewer from the perspective of FIG. 2). The opening 124 may extend along the longitudinal axis 126 through the support disk 110, the support arm 116, the guide plate 114, and various other components of the assembly 100. Particularly when the support disk 110, the support arm 116, and the guide plate 114 are rotatable, the opening 124 may be centralized with respect to these components to ensure balanced rotation and to limit vibration during the armouring process.

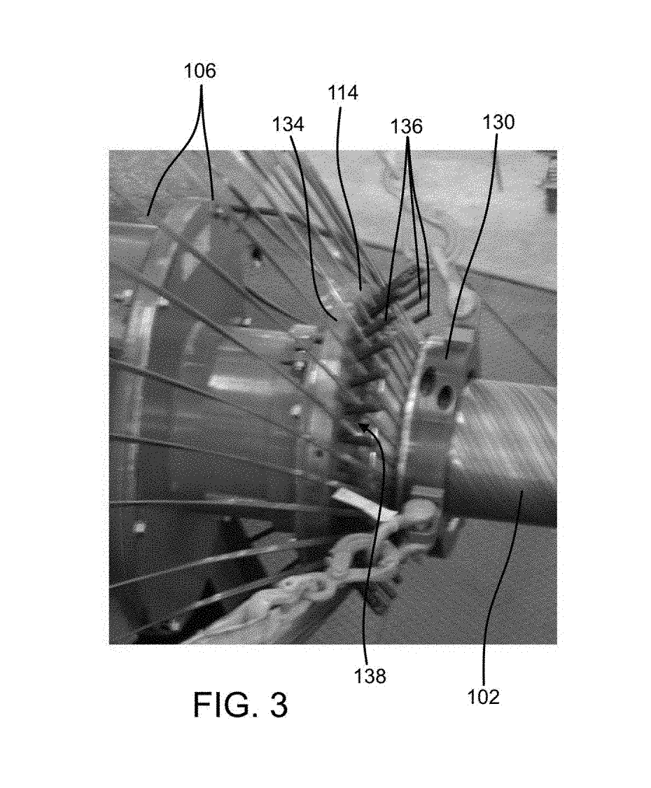

As the pipe 102 is fed through the assembly 100 (e.g., through a set of rollers that pull the pipe 102 through the assembly 100, which are not shown), it may be prevented from rotating about the longitudinal axis 126. The assembly 100, on the other hand (including the reels 108, the support disk 110, the support arm 116, and the guide plate 114), may rotate around the longitudinal axis 126 (and therefore around the pipe 102) as the pipe 102 is fed. While any rotational speed may be used, in one embodiment, the assembly 100 may rotate at a rate of about 10 revolutions per minute. At the same time, the strips 106, which rotate with the assembly 100 until they reach a closing die 130 (shown in FIG. 3), may be fed downstream through the support disk 110, the guide plate 114, and to the closing die 130 (FIG. 3). As a result, the strips 106 will be wound and wrapped around the outer surface 104 of the pipe 102 in a helical manner as the pipe 102 moves, and then locked to the outer surface 104 of the pipe 102 by way of the closing die 130 (of FIG. 3) to form a layer of armour. While only one assembly 100 is shown in FIG. 2, the armouring machine may include several assemblies for forming several layers of armour. It is contemplated that each layer may have a different number and/or orientation of metal strips, and/or each layer may be wound in a different direction (for example, adjacent layers may switch between clockwise and counter-clockwise).

In some applications, it may be desirable to feed each of the strips 106 through a preformer 132. Each perimeter opening 112 of the support disk 110 may be associated with a preformer 132, and the preformers 132 may be attached to (e.g., fixed to) the support disk 110. Herein, “fixed to” means “rigidly attached to” in a permanent or non-permanent manner. The preformers 132 may include a series of rollers (e.g., four rollers each) that bend or otherwise manipulate the shape of the strips 106 such that the strips 106 are cast with a tendency to form a helix. For example, the preformers 132 may flex the strips 106 past theft elastic limit to cast an appropriate helical path length (or helix straight length distance) within the strips 106, which may be determined by the striplayup angle and the diameter of the pipe 102. Advantageously, the helical cast of the strips 106 may enhance the performance of the armour layer, and reduce instances of shingles, since the strips 106 will have a tendency to assume their cast helical shape and lay more naturally (i.e., flat) on the outer surface 104 of the pipe 102. The rollers of the preformers 132 may be replaced with other preformers having rollers of a different size/orientation, and/or the preformers 132 may be adjusted, to adapt the assembly 100 to different application angles, different strip sizes, etc. In some embodiments, the preformers 132 may be adjusted automatically (and controlled by a control system).

After leaving the preformers 132, the strips 106 may extend to the guide plate 114. The guide plate 114 is shown in detail in FIG. 3, which is a photograph of one non-limiting exemplary embodiment. Referring to FIG. 3, the guide plate 114 may have a main body 134 for surrounding the pipe 102. The main body 134 may be circular in shape with a central opening for receiving the pipe. The guide plate 114 may further include a plurality of guide openings 138 or other structures on the outer circumference of the main body 134 (or at another suitable location). For example, in the depicted embodiment, the guide openings 138 are formed between adjacent pins 136 extending from the main body 134. Other embodiments are also contemplated (e.g., the guide openings 138 may be formed with eyelets or grommets attached to the main body 134, grooves or cavities in the main body 134, or any other suitable structure).

In the depicted embodiment, the pins 136, which may be formed of a hardened metal or other material, may be positioned such that the guide openings 138 guide the strips 106 to the closing die 130 in an appropriate orientation and with appropriate spacing. In particular, the pins 136 may be positioned such that they contact the strips 106 as the strips 106 are fed to the closing die 130 if/when the strips 106 would otherwise be offset from their appropriate positions for forming high-quality armour, without shingles. As described in more detail below, the guide plate 114 can be adjusted (e.g., rotated, or moved axially) with respect to upstream components to adjust the orientation and/or angle of the strips 106 as they enter the closing die 130 (and it is noted that the closing die 130 may rotate with the support disk 110).

FIG. 4 is an illustration showing a close-up view of a portion of the assembly 100 depicted in FIG. 2. As shown in FIG. 4, a support arm 116 may connect the support disk 110 to the guide plate 114. For example, a first end 118 of the support arm 116 may be coupled to the support disk 110 (e.g., through a hub 122 as shown), and a second end 120 of the support arm 116 may be coupled to (e.g., fixed to), the guide plate 114.

The support arm 116 may be rotatable with respect to the hub 122, and therefore also rotatable with respect to the support disk 110. The first end 118 of the support arm 116 may be rotatably-connected to the hub 122, and the first end 118 of the support arm 116 may be fixed to a first gear 140. Thus, the first gear 140 may be rotatable with respect to the hub 122, and rotation of the first gear 140 will cause rotation of the support arm 116. A connection flange 144 may connect the support arm 116 to the first gear 140, but the connection flange 144 is optional. The connection flange 144 may be advantageous, as it may act as a connection point for different tooling sizes. For example, the connection flange 144 may be capable of quickly and easily coupling to different support arms 116 having different dimensions (e.g., different diameters and/or lengths).

The first gear 140 may be engaged with a second gear 142. The second gear 142 may be coupled to the hub 122 and/or the support disk 110. In particular, a base portion 146 of the second gear 142, which may include an axle for the second gear 142, may be fixed with respect to the hub 122 and/or the support disk 110. Accordingly, actuation (i.e., rotation) of the second gear 142 may cause the first gear 140 to rotate, thereby causing rotating of the support arm 116. When the support arm 116 is attached to the guide plate 114 in a non-rotatable manner, this action will also cause rotation of the guide plate 114.

The second gear 142 may be actuated (i.e., rotated) through the use of a motor (e.g., within the base portion 146), through manual actuation by an operator, or by any other suitable device or method. Optionally, more than one second gear 142 may be included, such as two second gears 142 as shown in FIG. 4. It is contemplated that more than two second gears 142 may be included, and in one non-limiting exemplary embodiment, four second gears 142 are included, where the four second gears 142 are equally-spaced around the perimeter of the first gear 140. Such an embodiment may be advantageous because using four motors may control the size of the corresponding housing (e.g., the hub 122). To illustrate, when motors are housed within the hub 122, relatively small motors, equally space around the longitudinal axis, may allow the diameter of the hub 122 to be smaller than it would be if only one large motor was used, thus preventing the hub 122 from encroaching or otherwise interfering with the path of the strips 106. Further, by providing motors around the perimeter of the hub 122 (rather than in one location somewhere along the perimeter), the assembly 100 may remain balanced during rotation to avoid or limit vibration. Alternatively, only one actuation device may be provided with the second gears 142, and the additional second gears 142 may be used primarily for guidance. If the actuation device(s) are configured to rotate the guide plate 114 to rotate during production, they should be capable of providing an output torque that can overcome a potential rotational force provided to the guide plate 114 by way of the force transfer from tension in the strips (e.g., a component of strip tension, multiplied by the number of strips).

The gears 140 and 142 and actuation device (e.g., motor) may be included in a so-called actuation assembly 148, where the actuation assembly 148 effects rotation of the support arm 116 and the guide plate 114 about the longitudinal axis 126 (see FIG. 2) with respect to the support disk 110. Thus, the guide plate 114 can be rotated as needed (with respect to the support disk 110), either prior to machine setup, during an operation pause, and/or during an armouring operation, to ensure the pins 136 of the guide plate 114 are properly aligned for receiving the strips 106 and for feeding the strips 106 in an appropriate orientation to the closing die 130 (see FIG. 3). While not shown, in other embodiments, the actuation assembly 148 may be boated at the second end 120 of the support arm 116 (instead of at the first end 118), somewhere between the first end 118 and the second end 120, or at another suitable location.

Advantageously, the rotatable guide plate 114 may provide the ability to make fine adjustments of the armouring machine to provide a high-quality armour layer. To illustrate, if a shingle (or potential shingle) is detected or anticipated, the problem may be quickly resolved through a slight rotation of the guide plate 114 relative to the support disk 110. Unlike prior armouring machines, this may occur without completely removing the strips 106 from the guide plate 114 first and then re-stringing the machine afterwards, and therefore the timeline for making such an adjustment is substantially shorter with the present embodiments. Further, while not shown, the assembly may include a sensor (e.g., a laser or camera) for sensing a shingle or another issue within the armour. When a control system is included and coupled to the actuation device, the control system may use feedback from the sensor to make an automatic adjustment by rotating the guide plate 114, thereby allowing the assembly 100 may self-correct without manual intervention.

Another common problem associated with machine setup is the ease of stringing the strips 106 into the guide openings 138 of the guide plate 114 during machine setup. For example, particularly when a lot of strips 106 are used (e.g., 96 or more), it is relatively easy for an operator to be one, two, or even three places/units off when selecting a guide opening 138 for a strip 106, particularly the first strip strung, during machine setup. Instead of starting over when this error occurs (which is required with prior armouring machines), the present embodiments allow the guide plate 114 to be rotated into its appropriate position with respect to the support disk 110 to quickly correct this issue, thereby saving the time of removing the strips 106 from the guide plate 114 and then re-feeding them.

Additionally or alternatively, the guide plate 114 can be rotated as needed to account for different types of armour, such as armour formed with a different number of strips 106 and/or strips 106 of a different size, armour formed using a different application angle, a pipe 102 with a different outer diameter, etc. In some embodiments, initial conditions for each type of armour may be programmed into a control system such that when a certain application is selected, the guide plate 114 is rotated into its appropriate position automatically.

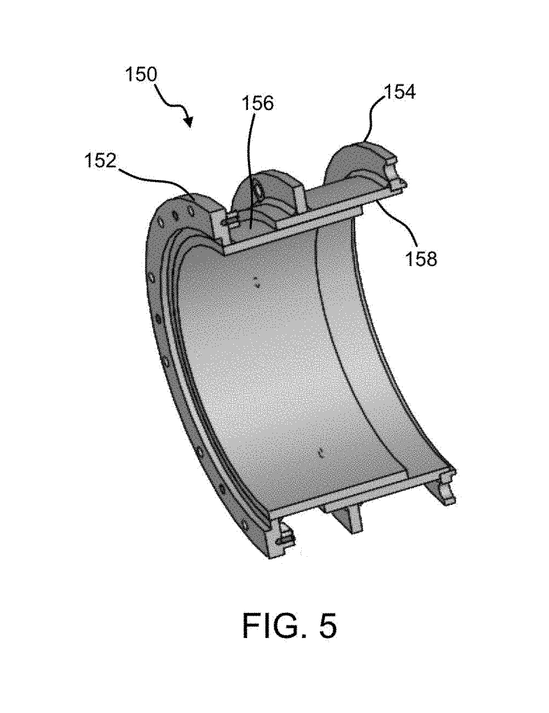

Still referring to FIG. 4, the guide plate 114 may also (or alternatively) be movable in the axial direction with respect to the support disk 110. To accomplish axial movement, the support arm 116 may have an adjustable length by way of an adjustable portion 150. For example, as shown, the adjustable portion 150 of the support arm 116 may include a first collar 152 having a male portion 156 that is associated with a female portion 158 of a second collar 154. The adjustable portion 150, including the first collar 152 (with the male portion 156) and the second collar 154 (with the female portion 158), is shown in isolation in FIG. 5. Referring to FIG. 5, the male portion 156 of the first collar 152 may be slidable with respect to the female portion 158 of the second collar 154, thereby providing a mechanism for adjusting the overall length of the support arm 116. A fastener (not shown) may additionally be included to fix the first collar 152 with respect to the second collar 154. For example, the fastener may include a bolt and nut, a pin, a screw, a clamp (e.g., a saddle clamp), or any other suitable structure.

Referring back to FIG. 4, the guide plate 114 may advantageously be adjustable, axially, such that it can be moved closer to, or further from, the support disk 110 during machine setup and/or during production. This axial adjustment may allow efficient accounting for different application angles of the strips 106, may correct an issue causing shingles, etc. Additionally, the adjustment may occur without replacing the support arm 116 with a support arm with a different length and potentially without restringing the strips 106 through the assembly 100, thereby saving time and increasing manufacturing efficiency. Like the relative rotation of the guide plate 114, the axial position of the guide plate 114 may be controlled manually (via operator intervention) or automatically. In one exemplary embodiment, the adjustable portion 150 may be motorized in a similar manner as the guide plate motorization, but with linear action rather than rotational action. For example, while not shown, a motor or other actuator may be coupled to at the adjustable portion 150 to provide automatic axial movement of the guide plate 114.

The automatic movement may be programmed in a controller, but it also (or alternatively) may be actuated by a user (e.g. through pressing a button). Automatic adjustment may be particularly advantageous since mechanical access to the adjustable portion 150 may be limited when the strips 106 are present. In some embodiments, a single control system may control adjustment of the preformers 132, the axial position of the guide plate 114 due to varying the length of the adjustable portion 150 of the support arm 116, and/or the rotational position of the guide plate 114 due to varying the rotational position of the support arm 116. Advantageously, a control system of this type may be capable of adapting the assembly 100 to account for a variety of armour types and correct a variety of issues (e.g., shingles) without significant downtime and without significant human intervention.

While various embodiments of the invention have been described, the invention is not to be restricted except in light of the attached claims and theft equivalents. Moreover, the advantages described herein are not necessarily the only advantages of the invention and it is not necessarily expected that every embodiment of the invention will achieve all of the advantages described.

We claim:

1. An assembly for an armouring machine, the assembly comprising:
a support disk, the support disk defining a central opening for receiving a pipe and a plurality of perimeter openings for receiving a plurality of strips, the support disk being rotatable about a longitudinal axis passing through the central opening;
a guide plate surrounding the longitudinal axis and including a plurality of guide structures, the guide structures being positioned for receiving the strips as they move downstream from the support disk; and
an actuation device that is mechanically coupled to the guide plate, wherein actuation of the actuation device causes rotation of the guide plate with respect to the support disk.

2. The assembly of claim 1, further comprising a support arm with a first end coupled to the support disk and a second end coupled to the guide plate.

3. The assembly of claim 2, wherein the actuation device is located at the first end of the support arm, and wherein the guide plate is fixed with respect to the second end of the support arm.

4. The assembly of claim 2,
wherein the actuation device includes a first gear and a second gear,
wherein the first gear is fixed with respect to the support arm,
wherein the second gear is driven by the actuation device, and
wherein the first gear and the second gear are engaged such that rotation of the second gear causes the support arm to rotate with respect to the support disk.

5. The assembly of claim 2, wherein a connection flange connects the second end of the support arm with the guide plate.

6. The assembly of claim 2, wherein the support arm includes an adjustable portion for adjusting an axial position of the guide plate with respect to the support disk.

7. The assembly of claim 6, wherein the adjustable portion includes a first collar with a male portion and a second collar with a female portion, wherein the male portion is slidably received by the female portion such that relative positions of the first collar and second collar can be adjusted.

8. The assembly of claim 1, wherein the actuation device includes a motor.

9. The assembly of claim 1, further comprising a closing die, the closing die being located adjacent the guide plate.

10. The assembly of claim 1, further comprising a preformer adjacent to at least one of the perimeter openings, the preformer having at least one roller for providing a helical cast to at least one of the strips.

11. The assembly of claim 1, wherein the guide plate includes a main body surrounding the longitudinal axis and a plurality of pins extending from the main body, the pins forming the plurality of guide structures as cavities located between adjacent pins.

12. An assembly for an armouring machine, the assembly comprising:
a support disk, the support disk defining a central opening for receiving a pipe and a plurality of perimeter openings for receiving a plurality of strips, the support disk being rotatable about a longitudinal axis passing through the central opening; and
a guide plate surrounding the longitudinal axis and including a plurality of guide structures, the guide structures being positioned for receiving the strips as they move downstream from the support disk; and
a support arm with a first end coupled to the support disk and a second end coupled to the guide plate, the support arm having an adjustable portion with a variable length,
wherein varying the length of the adjustable portion moves the guide plate axially along the longitudinal axis with respect to the support disk.

13. The assembly of claim 12, wherein the adjustable portion includes a first collar with a male portion and a second collar with a female portion, wherein the male portion is slidably received by the female portion such that relative positions of the first collar and second collar can be adjusted.

14. The assembly of claim 13, further comprising an actuation device that is mechanically coupled to the guide plate, wherein actuation of the actuation device causes rotation of the guide plate with respect to the support disk.

15. The assembly of claim 14,
wherein the actuation device includes a first gear and a second gear,
wherein the first gear is fixed with respect to the support arm,
wherein the second gear is driven by the actuation device, and
wherein the first gear and the second gear are engaged such that rotation of the second gear causes the support arm to rotate with respect to the support disk.

16. The assembly of claim 12, further comprising an actuation device coupled to the adjustable portion, wherein actuation of the actuation device varies the length of the adjustable portion.

17. The assembly of claim 16, wherein the actuation device includes a motor.

18. A method for forming an amour layer around an outer surface of a pipe, comprising:
feeding a strip through a support disk, the support disk defining a central opening for receiving a pipe and a perimeter opening for receiving the strip, the support disk being rotatable about a longitudinal axis passing through the central opening;
feeding the strip to a guide plate, the guide plate having a main body surrounding the longitudinal axis and a plurality of guide structures for receiving the strip as the strip moves downstream from the support disk; and
rotating the guide plate with respect to the support disk.

19. The method of claim 18, further comprising moving the guide plate axially with respect to the support disk.

20. The method of claim 18, wherein the rotation of the guide plate with respect to the support disk is caused by actuation of a motor coupled to a gear set, wherein a first gear of the gear set is fixed with respect to the support disk.
